(19) United States
(12) Patent Application Publication
(10) Pub. No.: US 2006/0291676 A1
(43) Pub. Date: Dec. 28, 2006

(54) Control panel door apparatus

(75) Inventors: Rick Messerle, Port Jervis, NY (US); Eran Schul, Milford, PA (US)

Correspondence Address: GREENBERG-TRAURIG, 1750 TYSONS BOULEVARD, 12TH FLOOR, MCLEAN, VA, 22102, US

(73) Assignee: Altec Lansing Technologies, Inc., Milford, PA (US)

(21) Appl. No.: 11/143,944

(22) Filed: Jun. 3, 2005

(51) Int. Cl. H04R 25/00

(52) U.S. Cl. 381/190

(57) ABSTRACT

A housing for electronic devices such as loudspeakers has a control panel on a first surface and a door hingedly connected to and adjacent to the panel. An opening mechanism releases the door from a closed position, allowing rotation of the door about an axis that extends through the hinged connection of the door and the housing such that the door continues movement until the door is positioned along a second surface of the housing and the panel is exposed. When in the fully opened position, the door may be received by a recess in the housing. When the housing is resting upon a surface, the door may be placed in a partially opened position wherein it lies flat on the surface.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of access doors for electronic equipment, and in particular to a loudspeaker having a door for covering a panel with controls.

### BACKGROUND OF THE INVENTION

Electronics and accessories are often configured to have a contemporary design while maximizing performance and efficiency. In a home or office, it is desirable to incorporate visually appealing, contemporary accessories along with other components in a room or at a workstation. In particular, loudspeakers that accompany a computer, gaming system, or other audio system should be designed to be aesthetically pleasing due to their placement near a focal point of the room or workstation.

The design of conventional loudspeakers for a computer, gaming system, or other audio system is often limited by a control panel for power, volume, bass, treble, balance, or jacks for input/output. The knobs and buttons on the control panel are undesirable in a contemporary design aiming to offer minimal elements exposed to the user. Often, knobs and buttons are positioned on the front of the loudspeaker housing for accessibility to the user. However, the contemporary design and clean lines of the loudspeaker are often sacrificed due to the unsightly location of the control panel, and the controls are exposed to inadvertent or unauthorized manipulation.

### SUMMARY OF THE INVENTION

Accordingly, the present invention is directed to a control panel door for electronic devices that substantially obviates one or more of the problems due to limitations and disadvantages of the related art.

In one embodiment of the present invention, a loudspeaker has a control panel positioned on the front surface of its housing to maintain the accessibility of the controls. A door is positioned over the control panel to conceal the controls when they are not in use. When the door is opened, the door pivots around the housing to the bottom of the housing where the door is concealed from view by a recess in the housing. The control panel is exposed and the door remains hidden.

In another embodiment, a loudspeaker housing includes at least one speaker driver positioned on a front face of the loudspeaker housing. A panel is provided on a first surface of the loudspeaker housing, the panel having a loudspeaker control mechanism, an input jack, and an output jack, or the like. A door is hingedly connected to and adjacent to the panel, the door having an open position and a closed position such that the door covers all or part of the panel when the door is in the closed position and the door exposes the at least one component of the panel when the door is in the open position. An opening mechanism is provided on the loudspeaker housing for releasing the door from the closed position. The operation of the opening mechanism allows the unobstructed rotation of the door about an axis that extends through the hinged connection of the door and the loudspeaker housing such that the door continues movement until the door is positioned along a second surface of the loudspeaker housing, exposing at least one component of the panel. A spring mechanism is proximate the hinged connection of the door for allowing movement of the door. The door may rotate through an unobstructed path of approximately 270 degrees from the first surface to the second surface. A recessed region in the second surface of the loudspeaker housing accommodates the door. The door is substantially flush with the first surface of the loudspeaker housing when the door is in the closed position.

In yet another embodiment of the present invention, a loudspeaker housing includes at least one loudspeaker driver, at least one control located on a front surface of the loudspeaker housing, and a door hingedly attached along the edge between the front surface and a bottom surface of the loudspeaker housing, the door concealing the control from view when in a closed position. A door opening mechanism is positioned to release or secure the door on the front surface or side surface of the loudspeaker housing. Activation of the door opening mechanism releases the door from the closed position and allows the door to pivot approximately 270 degrees to an open position and expose the control. A spring mechanism biases movement of the door. A recess is provided in the bottom surface of the housing to receive the door. The door may be approximately aligned with the front surface or side surface in the open or closed position.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1a is a front view of a pair of loudspeakers according to an embodiment of the present invention.

FIG. 1b is a rear view of a pair of loudspeakers according to an embodiment of the present invention.

FIG. 1c is a perspective view of a loudspeaker according to an embodiment of the present invention.

FIGS. 2a and 2b are perspective and side views, respectively, of a loudspeaker control panel door in operation according to an embodiment of the present invention.

FIG. 3 is a perspective view of a loudspeaker with a door in an open position according to an embodiment of the present invention.

FIG. 4a is a perspective view of a loudspeaker with a door in a fully open position according to an embodiment of the present invention.

FIG. 4b is a bottom view of a loudspeaker with a door in a fully open position according to an embodiment of the present invention.

FIG. 5 is a cross-sectional view through the line A-A of FIG. 1a.

FIG. 6 is a an exploded view of the loudspeaker according to an embodiment of the present invention.

### DETAILED DESCRIPTION OF THE PREFERRED EMBODIMENT

Reference will now be made in detail to illustrative embodiments of the present invention, examples of which are shown in the accompanying drawings.

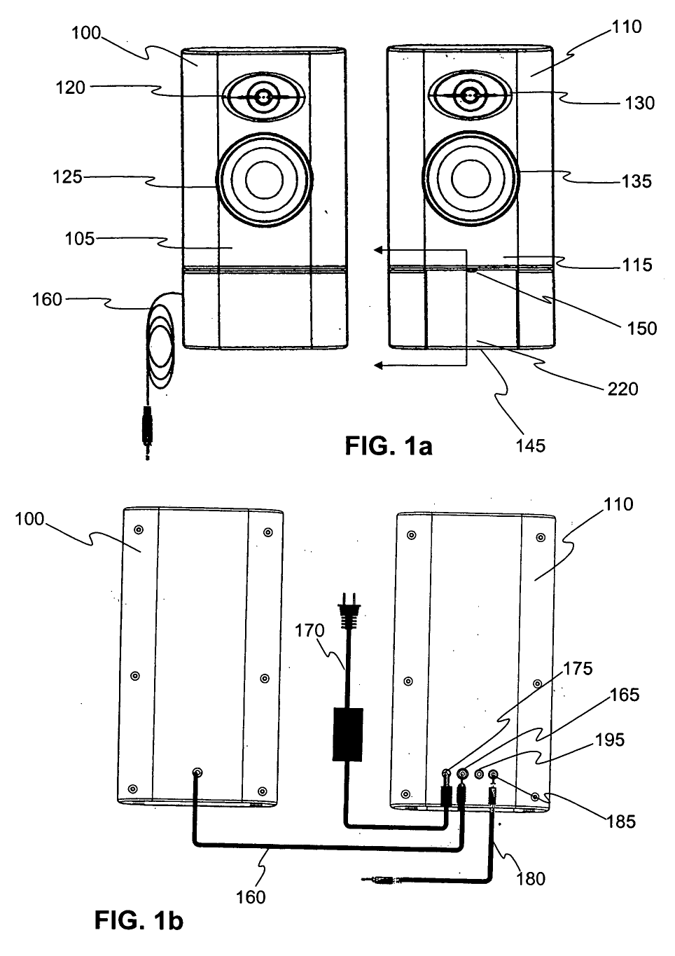

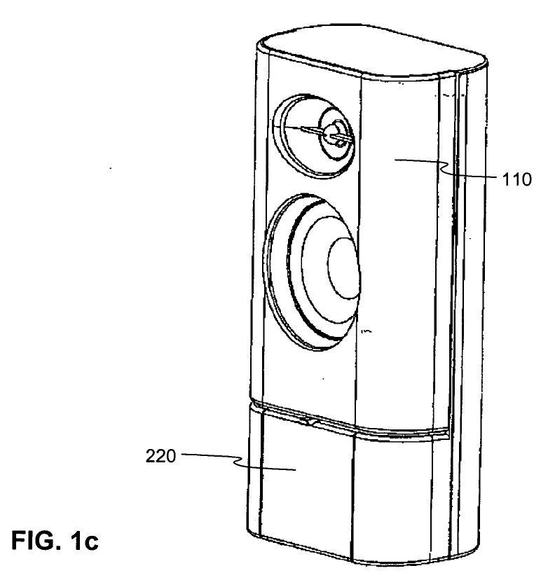

Referring to FIGS. 1a to 1c, a pair of speaker housings 100, 110 according to an embodiment of the present invention is shown. The speaker housings 100, 110 may be connected to any type of audio system, such as a gaming system, personal computer, portable media player, stereo receiver, or other audio source known to one of ordinary skill in the art, or may be integrated into a portable media reproduction system such as that shown in U.S. patent application Ser. No. 10/836,113 filed Apr. 30, 2004, the entire disclosure of which is incorporated herein by reference. The speaker housings 100, 110 may be positioned on a desk or shelf, mounted on a wall, mounted on speaker stands, or any other known configuration of positioning loudspeakers.

The speaker housings 100, 110 have loudspeaker drivers 120, 125, 130, 135 positioned on a front surface 105, 115 of the speaker housings 100, 110. Although this exemplary embodiment has two drivers in each speaker housing, any number of drivers and speaker housings may be used, as appreciated by one of ordinary skill. In one embodiment, the speaker housing 110 includes an audio amplifier (not shown). A cable 160 is used to connect the speaker housing 100 with the speaker housing 110 so that speaker housings 100, 110 can share a power source, audio source, and controls.

Referring to FIG. 1b, a rear view of the speaker housings 100, 110 is shown. The speaker housings 100, 110 have a plurality of cables and jacks for power as well as receiving and sending audio signals and/or data. However, the speaker housings 100, 110 can have any wiring configuration known to one of ordinary skill in the art. In this exemplary embodiment having left and right stereo speaker housings 100, 110, cable 160 connects right speaker housing 100 to a jack 165 in left speaker housing 110. A jack 175 connects a power cord 170 for supplying power to the speaker housings 100, 110. Alternatively, speaker housings 100, 110 may be battery-powered or receive power from the audio source. An input jack 185 connects a cable 180 to a personal computer, gaming system, personal media player or other audio source. An auxiliary input jack 195 is provided for secondary uses other than those connected to jack 185.

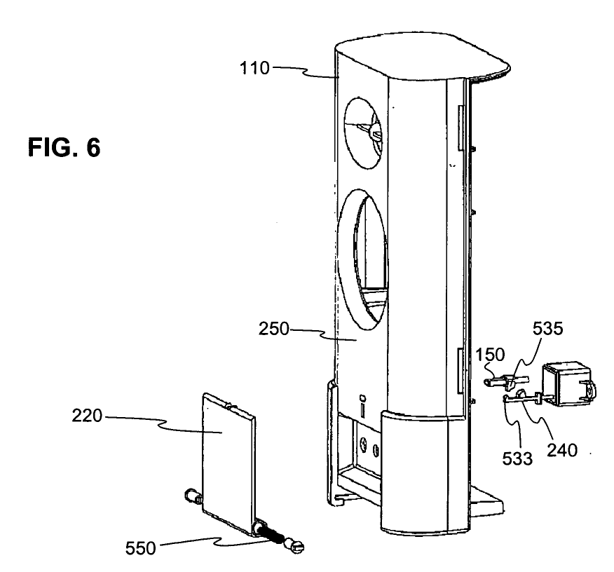

Referring to FIGS. 1a and 1c, a door 220 on speaker housing 110 is shown in a closed position. When in a closed position, the door 220 is substantially flush with the front surface 115 of speaker housing 110. It should be noted that the “front” surface as referred to herein can be any surface of the housing which includes a control panel. In one embodiment, a lower edge of the door 220 is hinged to the speaker housing 110 at an edge proximate the front surface 115 and a bottom surface 145. The door 220, therefore, revolves around an axis that extends along the edge between the front surface 115 and the bottom surface 145. In one embodiment, the hinge may be located on another edge of the door 220, depending on the positioning of the door 220 about the speaker housing 110. The door 220 may be coupled to the speaker housing 110 with a hinge, or with alternative means of pivotably, rotatably, or otherwise mounting the door, as will be appreciated by one of ordinary skill. In one embodiment, the door 220 has a spring mechanism, as shown in FIG. 6 and discussed in detail below, housed proximate the hinge to assist in the movement of the door 220. The door may take various forms, including that of a flat or curved solid surface, a perforated surface, a gate that simply obstructs access, or the like.

Situated on the housing of speaker housing 110 proximate an upper edge of the door 220 is an opening mechanism 150, which is used to open the door 220 and to secure the door 220 in a closed position. In the exemplary embodiment shown, the opening mechanism 150 is a releasable latch mechanism. The opening mechanism, however, may be any releasable and securable mechanism known to one of ordinary skill in the art.

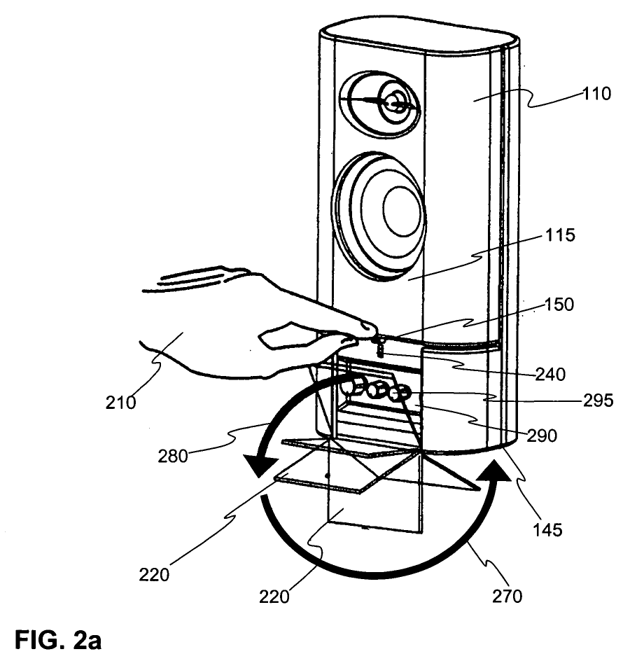

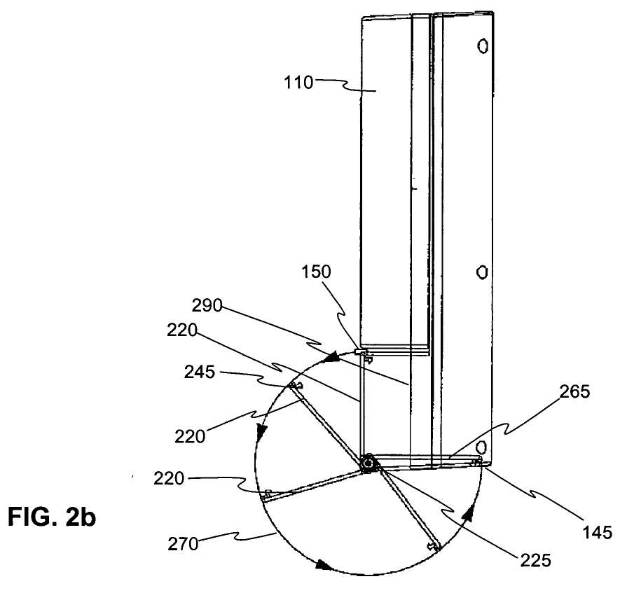

Upon activation of the opening mechanism 150, the door 220 pivots or swings about an edge of the speaker housing 110. Referring to FIGS. 2a and 2b, a door 220 is illustrated in various stages of operation. The door 220 is preferably hinged to a speaker housing 110 at an edge 225 proximate a front surface 115 and a bottom surface 145. In the closed position (FIGS. 1a and 1c), a hook 245 on the door 220 grips a latching component 240 on an opening mechanism or button 150. In one embodiment, a user 210 activates the opening mechanism 150 by applying pressure to the opening mechanism 150. In one embodiment, the opening mechanism 150 can be configured such that the user applies pressure in a direction away from the door 220, towards the door 220, or any other direction. In one embodiment, the opening mechanism 150 can be positioned behind door 220, whereby the user activates the opening mechanism 150 by apply pressure to the door 220 in an area proximate the opening mechanism 150. By activating the opening mechanism 150, the latching component 240 is disengaged from, and allows the hook 245 on the door 220 to release. In one embodiment, when the opening mechanism 150 is activated, the spring mechanism provides a force for pivoting the door 220.

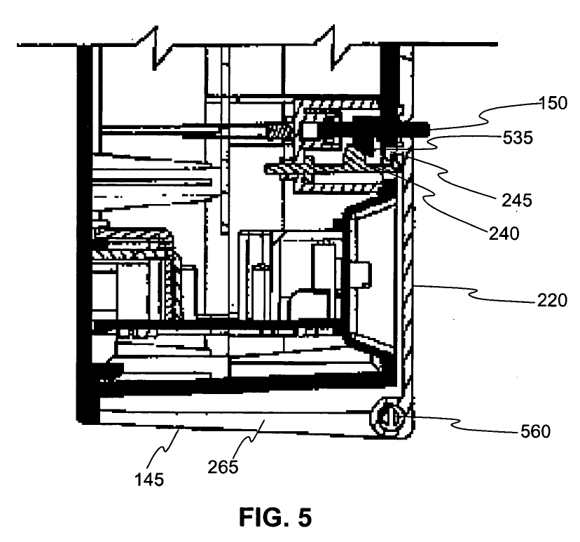

Referring to FIG. 5, a cross-sectional view of section A-A in FIG. 1a, and FIG. 6, an exploded view, a mechanism for releasing and securing a door 220 is shown. In one embodiment, a button 150 is depressed, applying a downward force via a downwardly extending flange 535 to a frictionally engaged latch 240. A second flange 533 extending upwardly from the latch 240 is in frictional engagement with a hook 245 on the door 220. As the latch 240 moves downwards, the second flange 533 also moves downwards until no longer engaging the hook 245. The door 220 is thereby released. In one embodiment, a spring 550 at the hinge 560 enables the door 220 to pivot.

The door 220 pivots around the axis of rotation from the front surface 115 of the speaker housing 110. If unobstructed, the door 220 pivots around the axis of rotation to a recess 265 on the bottom surface 145. The door 220 travels a path 280, 270 (FIG. 2a) to an end position on the bottom surface 145 when the door 220 has an unobstructed route of travel. In one embodiment, the bottom surface 145 has a recess 265 to conceal the door 220 when the door 220 is in the end position. As a result, the access or control panel 290, which is concealed behind the door 220 when the door 220 is in the closed position, is now accessible and the door 220 is hidden from view. The control panel 290 may be any panel, face, etc. which includes at least one button, knob, dial, input/output jack, display, LED, keypad, indicator, or the like.

When the bottom surface 145 of the speaker housing 110 is placed on a desk or other surface, the door 220 has an obstructed path. As a result, the door 220 follows a path 280, whereby the door 220 is restricted by the surface of the obstruction. In one embodiment, the obstructed door 220 remains visible. In one embodiment, sufficiently lifting the speaker housing 110, however, will cause the door to continue along path 270 and position itself on the underside 145 of the speaker housing 110. In one embodiment, a sliding mechanism is provided (not shown) to permit door 220 to slide at least partially into recess 265 when its path 270 is obstructed.

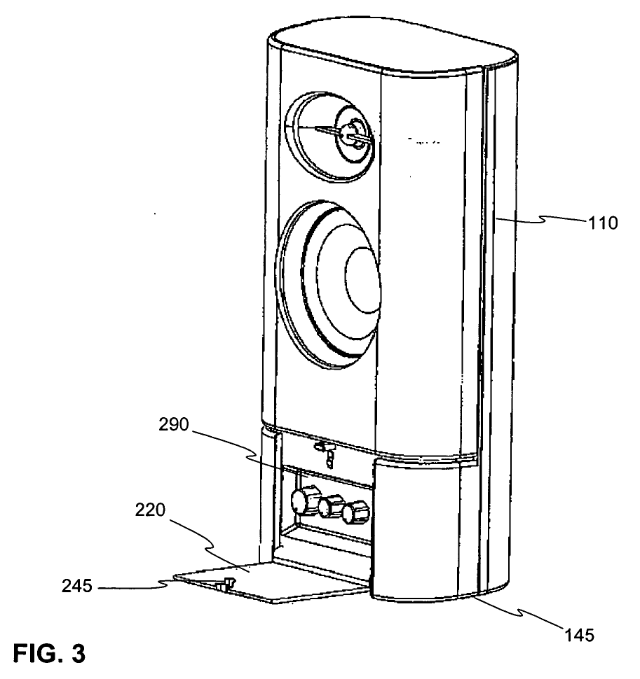

Referring to FIG. 3, a speaker housing 110 is shown having a door 220 in a partially open position, wherein the speaker housing 110 has been opened as it is resting upon a resting surface such as a table, desk, or the like (not shown). A bottom surface 145 of the speaker housing 110 is situated on the resting surface. As a result, when the door 220 is opened, the door 220 is unable to complete a rotation to an end position at the bottom surface 145 of the speaker housing 110. In one embodiment, the door 220 remains substantially aligned with the resting surface. Nevertheless, a control panel 290 is exposed when the door 220 is in this partially open position. If desired, sufficiently lifting the speaker housing 110 will cause the door 220 to have an unobstructed path and, thus, to pivot to the recess 265 on the bottom 145 of the speaker housing 110.

In the end position or in a partially open position of the door 220, a control panel 290 is revealed. In one embodiment, the control panel 290 includes one or more controlling mechanisms 295 for controlling for the properties of the loudspeaker drivers 120, 125, 130, 135. The controlling mechanisms 295 may be buttons, knobs, input jacks, output jacks, keypad, or the like. For example, the control panel 290 may have a power control, volume control, bass control, treble control, balance control, an input jack, or an output jack. In one embodiment, the control panel 290 includes at least one display, LED, indicator, or the like for indicating one or more properties of the system.

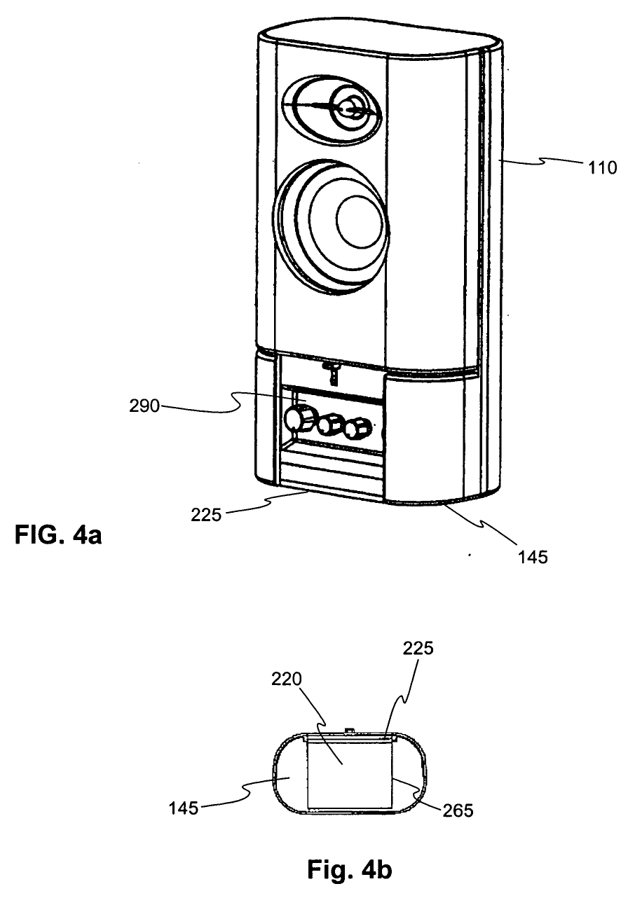

Referring to FIGS. 4a and 4b, a speaker housing 110 is shown. In this exemplary embodiment, the speaker housing 110 may be mounted directly to a wall from the back surface of the speaker housing 110, may rest upon a support surface or speaker stand, may be mounted to a wall or ceiling via a mounting bracket, or may employ other mounting or support means. In the open position, a door 220 is able to complete a pivot of approximately 270 degrees to an end position in a recess 265 on a bottom surface 145 of the speaker housing 110. Because the door 220 is shown in the fully open position, only a portion of a hinged component 225 of the door 220 is exposed to a user from a frontal view of speaker housing 110. A control panel 290 is exposed, and the user is able to view the control panel 290 and/or adjust the controls 295 thereupon.

After the user utilizes the control panel 290, the user may secure the door 220 in a closed position to again conceal the control panel 290. Referring again to FIG. 2, the user 210 returns the door 220 in the direction opposite that shown at 270, 280 to the closed position. The latching component 240 secures the hook 245 on the door 220. As seen in FIG. 1a, when secured by the opening mechanism 150, the door 220 remains in a closed position to cover the control panel.

Although certain embodiments of the present invention are directed towards loudspeakers, the present invention may be used in any similar field wherein it is desirable to utilize a door for concealing a panel, controls, or the like.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A loudspeaker comprising:
a housing having a wall mount and at least one speaker driver;
a panel on a first surface of the housing, the panel comprising at least one component selected from the group consisting of a loudspeaker control mechanism, an input jack, an output jack, a display, or a LED;
a door rotatably connected to the housing, wherein the door has an open position and a closed position, the door covering at least part of the panel when the door is in the closed position and the door exposing the at least one component of the panel when the door is in the open position; and
an opening mechanism on the loudspeaker housing for releasing the door from the closed position;
wherein the operation of the opening mechanism when the housing is supported from the wall mount allows the door to rotate along a path that begins with the door in the closed position, and ends with the door positioned adjacent to a second surface of the loudspeaker housing and exposing the at least one component of the panel.

2. The loudspeaker of claim 1, further comprising a spring mechanism urging the rotation of the door away from the panel when the opening mechanism is operated.

3. The loudspeaker of claim 1, wherein the path of rotation is approximately 270 degrees.

4. The loudspeaker of claim 1, further comprising a recessed region in the housing for accommodating the door.

5. The loudspeaker of claim 1, wherein the door is substantially flush with the first surface of the loudspeaker housing when the door is in the closed position.

6. The loudspeaker of claim 1, further comprising a bottom surface for supporting the weight of the housing on a resting surface, and wherein the operation of the opening mechanism when the housing is supported on a resting surface allows the door to rotate along a shortened path that begins with the door in the closed position, and ends with the door positioned adjacent to the resting surface and exposing the at least one component of the panel.

7. The loudspeaker of claim 6, wherein the shortened path of rotation is approximately 90 degrees.

8. A loudspeaker comprising:
a housing having a base, the base being adapted to support housing on a resting surface;
at least one loudspeaker driver affixed to the housing;
a panel affixed to the housing;
a door hingedy attached to the loudspeaker housing, wherein the door conceals at least a portion of the panel from view when in a closed position;
a door control mechanism positioned to release the door from, or secure the door in, the closed position;
a door recess in the housing for receiving the door, and wherein when the door is in an end position the door is at least partially within the door recess; and
whereby releasing the door with the door control mechanism disengages the door from the closed position and allows the door to pivot toward the end position, thereby exposing the at least a portion of the panel concealed by the door in the closed position.

9. The loudspeaker of claim 8, further comprising a spring mechanism urging the door away from the closed position.

10. The loudspeaker of claim 8, further comprising a door recess in the housing for receiving the door, and wherein when the door is in the end position the door is at least partially within the door recess.

11. The loudspeaker of claim 8, wherein the panel is affixed to a recess in the housing.

12. The loudspeaker of claim 8, wherein the housing has a front and a bottom surface, and the door is hingedly attached along an edge between the front and bottom surfaces of the housing;

13. The loudspeaker of claim 12, wherein the door is approximately aligned with the front surface of the housing when the door is in the closed position.

14. The loudspeaker of claim 13, further comprising a door recess in the bottom surface of the housing for receiving the door, and wherein when the door is in the end position the door is at least partially within the door recess.

15. The loudspeaker of claim 8, wherein a resting surface supporting the housing from the base obstructs the door from pivoting to the end position, but permits the door to pivot a smaller amount to an open position exposing the at least a portion of the panel concealed by the door in the closed position.

16. The loudspeaker of claim 15, wherein the first amount is greater than 160 degrees, and the smaller amount is approximately 90 degrees.

17. The loudspeaker of claim 8, wherein the housing has a surface, and wherein the door is approximately aligned with the surface of the housing when the door is in the open position and when the door is in the closed position.

18. The loudspeaker of claim 12, wherein the door pivots 270 degrees between the closed position and the end position.

19. The loudspeaker of claim 12, wherein the door pivots in the range of 260 to 280 degrees between the closed position and the end position.
